(19) United States
(12) Patent Application Publication
(10) Pub. No.: US 2026/0147944 A1
(43) Pub. Date: May 28, 2026

(54) Chip System and Communication Device

(71) Applicant: HUAWEI TECHNOLOGIES CO., LTD., Shenzhen (CN)

(72) Inventors: Dong Yu, Shanghai (CN); Yu Liu, Shanghai (CN)

(73) Assignee: HUAWEI TECHNOLOGIES CO., LTD., Shenzhen (CN)

(21) Appl. No.: 19/453,114

(22) Filed: Jan. 20, 2026

Related U.S. Application Data
(63) Continuation of application No. PCT/CN2024/105504, filed on Jul. 15, 2024.

(30) Foreign Application Priority Data
Jul. 21, 2023 (CN) 202310910216.0

(51) Int. Cl. G06F 21/79

(52) U.S. Cl. CPC G06F 21/79

(57) ABSTRACT

A chip system includes: a memory die; and at least two non-memory dies, including a first non-memory die and a second non-memory die. The first non-memory die includes a first controller, the second non-memory die includes a second controller, and the first controller and the second controller are configured to control access to the memory die.

### CROSS-REFERENCE TO RELATED APPLICATIONS

This is a continuation of International Patent Application No. PCT/CN2024/105504, filed on Jul. 15, 2024, which claims priority to Chinese Patent Application No. 202310910216.0, filed on Jul. 21, 2023, which are both incorporated by reference.

### TECHNICAL FIELD

This disclosure relates to the field of communication technologies, and in particular, to a chip system and a communication device.

### BACKGROUND

As a scale of a system on chip (SoC) increases, an area of the SoC increases continuously. However, manufacturing yield of the chip declines as the area increases. If an area of a complete SoC is excessively large, the SoC needs to be distributed across a plurality of dies for implementation. The plurality of dies may include two types of dies: memory dies and non-memory dies. For example, the memory die may include a dynamic random-access memory (DRAM), and the non-memory die may include a central processing unit (CPU), a modem, and the like.

In some instances, most of the non-memory dies in the plurality of dies need to use the memory dies to perform respective functions. Therefore, how to dispose the plurality of dies to improve efficiency of data communication between the non-memory dies while ensuring functions of the non-memory dies is an urgent problem that needs to be resolved.

### SUMMARY

This disclosure provides a chip system and a communication device, which are configured to: when a plurality of dies are disposed, improve efficiency of data communication between non-memory dies while ensuring functions of the non-memory dies.

To achieve the foregoing objectives, the following technical solutions are used in embodiments of this disclosure.

According to a first aspect, a chip system is provided. The chip system includes: a memory die, where the memory die may be a die having a storage function, for example, the memory die may include a DRAM; and at least two non-memory dies, including a first non-memory die and a second non-memory die, where the non-memory die may be a die having a data processing function or a computing function, and the non-memory die may access the memory die. The first non-memory die includes a first controller, the second non-memory die includes a second controller, and the first controller and the second controller are configured to control access to the memory die.

In the foregoing technical solution, both the first non-memory die and the second non-memory die may access the memory die by using the respective controllers, so that the first non-memory die and the second non-memory die can use the memory die to perform respective functions. Both the first non-memory die and the second non-memory die may access the memory die. In other words, different non-memory dies may access a same memory die. In this way, the first non-memory die and the second non-memory die may implement data communication by using the memory die, to improve efficiency of data communication between different non-memory dies. In addition, this can save the memory die and reduce costs.

In a possible implementation of the first aspect, at least two interfaces of the memory die are respectively coupled to a first interface of the first non-memory die and a first interface of the second non-memory die for the first controller and the second controller to control access to the memory die. In this way, the first non-memory die may access the memory die through the first interface of the first non-memory die, and the second non-memory die may access the memory die through the first interface of the second non-memory die. A second interface of the first non-memory die is coupled to a second interface of the second non-memory die for the first controller to communicate with the second controller, so that the first non-memory die and the second non-memory die can directly communicate with each other through the second interfaces. For example, the first non-memory die and the second non-memory die may negotiate a control right of the memory die through the second interfaces. In the foregoing possible implementation, the first controller of the first non-memory die and the second controller of the second non-memory die may negotiate the control right of the memory die through the corresponding second interfaces, so that the memory die does not need to be greatly improved, and storage density and flexibility of the memory die are not reduced.

In a possible implementation of the first aspect, the at least two non-memory dies access the memory die through time division multiplexing. In other words, the at least two non-memory dies may access the memory die at different times. For example, when the at least two non-memory dies include the first non-memory die and the second non-memory die, the first non-memory die and the second non-memory die may access the memory die through time division multiplexing. In the foregoing possible implementation, each of the at least two non-memory dies may access the memory die at different times, so that the memory die does not need to be greatly improved, and storage density and flexibility of the memory die are not reduced.

In a possible implementation of the first aspect, the first controller is configured to send first indication information through the second interface of the first non-memory die, where the first indication information indicates that the first non-memory die is to access the memory die; and/or the second controller is configured to send second indication information through the second interface of the second non-memory die, where the second indication information indicates that the second non-memory die is to access the memory die. In the foregoing possible implementation, the first controller of the first non-memory die and the second controller of the second non-memory die may negotiate the control right of the memory die through the second interfaces, so that the memory die does not need to be greatly improved, and storage density and flexibility of the memory die are not reduced.

In a possible implementation of the first aspect, the at least two non-memory dies further include a third non-memory die, the third non-memory die includes a third controller, and the third controller is configured to control access to the memory die. In the foregoing possible implementation, the third non-memory die may access the memory die by using the third controller, so that the third non-memory die can use the memory die to perform a function of the third non-memory die. In addition, different non-memory dies may access a same memory die. In this way, the third non-memory die and another non-memory die may implement data communication by using the memory die, to improve efficiency of data communication between different non-memory dies. In addition, this can save the memory die and reduce costs.

In a possible implementation of the first aspect, the at least two interfaces of the memory die are further coupled to a first interface of the third non-memory die for the third controller to control access to the memory die, so that the third non-memory die can use the memory die to perform a function of the third non-memory die. In addition, any two of the at least two non-memory dies may implement data communication by using the memory die, to improve efficiency of data communication between non-memory dies. A second interface of the third non-memory die is coupled to both the second interface of the first non-memory die and the second interface of the second non-memory die for the third controller to communicate with the first controller and the second controller. In this way, the third non-memory die may negotiate the control right of the memory die with another non-memory die through the second interfaces, to access the memory die in a time division multiplexing manner.

In a possible implementation of the first aspect, the third controller is configured to send third indication information through the second interface of the third non-memory die, where the third indication information indicates that the third non-memory die is to access the memory die. In the foregoing possible implementation, the third non-memory die may negotiate the control right of the memory die through the second interfaces, so that the memory die does not need to be greatly improved, and storage density and flexibility of the memory die are not reduced.

In a possible implementation of the first aspect, the memory die and a part of the at least two non-memory dies are packaged together; or the memory die and the at least two non-memory dies are packaged together. In the foregoing possible implementation, the memory die and the at least two non-memory dies or a part of the at least two non-memory dies are packaged together, so that an integration level of the chip system can be improved, and an area of the chip system can be reduced.

In a possible implementation of the first aspect, each of the at least two non-memory dies includes a controller, and the controller is configured to control access to the memory die. In the foregoing possible implementation, each of the at least two non-memory dies may access the memory die by using the respective controller, and the controller does not need to be integrated into the memory die, so that flexibility of the memory die is not affected.

In a possible implementation of the first aspect, the at least two non-memory dies include at least one of the following: a CPU, a modem, an image signal processor (ISP), a digital signal processor (DSP), a graphics processing unit (GPU), a neural processing unit (NPU), a tensor processing unit (TPU), or a network interface card. In the foregoing possible implementation, diversity and selection flexibility of the non-memory die can be improved.

According to a second aspect, a communication device is provided. The communication device includes a printed circuit board and the chip system that is disposed on the printed circuit board and that is provided in any one of the first aspect or the possible implementations of the first aspect. Optionally, the communication device includes a mobile terminal. For example, the mobile terminal may include a mobile phone, a tablet computer, a notebook computer, a video camera, a camera, a wearable device, a vehicle-mounted device, and the like.

It may be understood that, for beneficial effects that can be achieved by any communication device provided above, refer to the beneficial effects in the chip system provided above. Details are not described herein again.

### BRIEF DESCRIPTION OF DRAWINGS

FIG. 1 is a diagram of a structure of a dual-port DRAM.

FIG. 2 is a diagram of a structure of another dual-port DRAM.

FIG. 3 is a diagram of a structure of a terminal device according to an embodiment of this disclosure.

FIG. 4 is a diagram of a structure of a chip system according to an embodiment of this disclosure.

FIG. 5 is a diagram of a structure of another chip system according to an embodiment of this disclosure.

FIG. 6 is a diagram of a structure of still another chip system according to an embodiment of this disclosure.

FIG. 7 is a diagram of a structure of another chip system according to an embodiment of this disclosure.

FIG. 8 is a diagram of a structure of still another chip system according to an embodiment of this disclosure.

### DETAILED DESCRIPTION

The making and use of embodiments are discussed in detail below. It should be appreciated, however, that many concepts provided in this disclosure may be implemented in a plurality of specific environments. Specific embodiments discussed are merely illustrative of specific ways to implement and use this description and this technology, and do not limit the scope of this disclosure.

Unless otherwise defined, all technical terms used herein have the same meaning as those commonly known to a person of ordinary skill in the art.

Circuits or other components may be described as or referred to as “configured to” perform one or more tasks. In this case, the term “configured to” is used for implying a structure by indicating that a circuit/component includes a structure (for example, a circuit system) that performs one or more tasks during operation. Therefore, even when a specified circuit/component is currently not operable (for example, not opened), the circuit/component may also be referred to as being configured to perform the task. The circuit/component used in conjunction with the phrase “configured to” includes hardware, for example, a circuit for performing an operation.

The following describes the technical solutions in embodiments of this disclosure with reference to the accompanying drawings in embodiments of this disclosure. In descriptions of this disclosure, unless otherwise specified, “/” represents an “or” relationship between associated objects. For example, A/B may represent A or B. In this disclosure, “and/or” describes only an association relationship for describing associated objects and represents that three relationships may exist. For example, A and/or B may represent the following three cases: Only A exists, both A and B exist, and only B exists, where A or B may be singular or plural.

In addition, in the descriptions of this disclosure, “a plurality of” means two or more than two unless otherwise specified. “At least one of the following items (pieces)” or a similar expression thereof means any combination of these items, including a singular item (piece) or any combination of plural items (pieces). For example, at least one item (piece) of a, b, or c may indicate: a, b, c, a and b, a and c, b and c, or a, b, and c, where a, b, and c may be singular or plural.

To clearly describe the technical solutions in embodiments of this disclosure, terms such as “first” and “second” are used in embodiments of this disclosure to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

In addition, in embodiments of this disclosure, the word “example” or “for example” is used to represent giving an example, an illustration, or a description. Any embodiment or design scheme described as an “example” or “for example” in embodiments of this disclosure should not be explained as being more preferred or having more advantages than another embodiment or design scheme. Exactly, use of the terms such as “example” or “for example” is intended to present a related concept in a specific manner for ease of understanding.

Before embodiments of this disclosure are described below, related background in this disclosure are first described.

As a scale of an SoC increases, an area of the SoC increases continuously. However, manufacturing yield of the chip declines as the area increases. If an area of a complete SoC is excessively large, the SoC needs to be distributed across a plurality of dies for implementation. The plurality of dies may include two types of dies: memory dies and non-memory dies. Most of non-memory dies in the plurality of dies need to use the memory dies to perform respective functions. Therefore, how to dispose the plurality of dies to improve efficiency of data communication between the non-memory dies while ensuring functions of the non-memory dies is an urgent problem that needs to be resolved.

In a related technology, the memory die may be improved. In other words, the memory die is implemented by using a dual-port DRAM. The dual-port DRAM has two access ports, and allows simultaneous access by two non-memory dies, thereby improving efficiency of data communication between non-memory dies while ensuring functions of the non-memory dies.

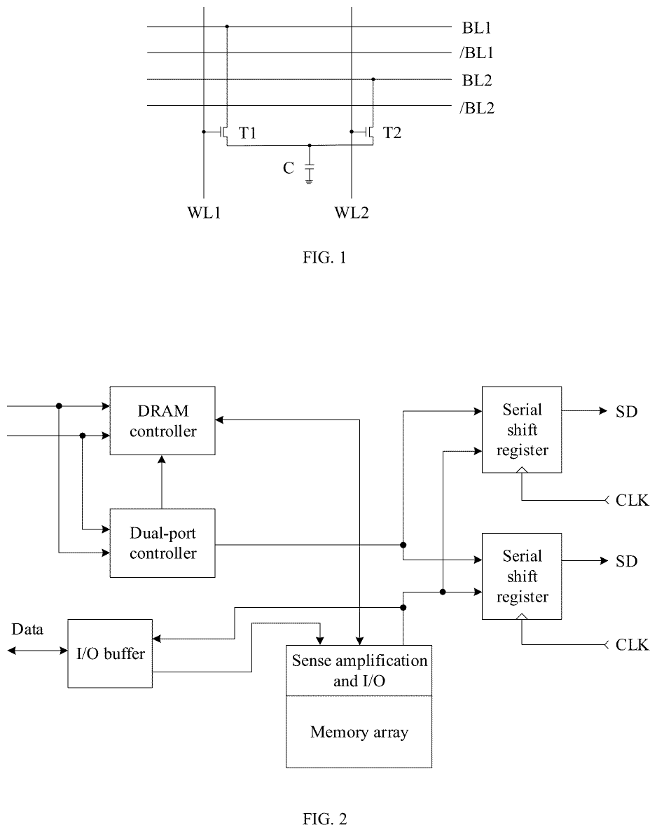

FIG. 1 is a diagram of a structure of a dual-port DRAM. The dual-port DRAM allows simultaneous access through two ports, so that two non-memory dies can simultaneously access the DRAM through the two ports. In the dual-port DRAM, one storage unit (namely, one capacitor C) is correspondingly coupled to two transistors (represented as T1 and T2), and each transistor is coupled to one bit line (BL) and one word line (WL). For example, the transistor T1 is coupled to a bit line BL1 and a word line WL1, and the transistor T2 is coupled to a bit line BL2 and a word line WL2. In FIG. 1, BL1 represents inversion of the bit line BL1, and BL2 represents an inversion of the bit line BL2.

FIG. 2 is a diagram of a structure of another dual-port DRAM. The dual-port DRAM also allows simultaneous access through two ports, so that two non-memory dies can simultaneously access the DRAM through the two ports. The dual-port DRAM is integrated with a DRAM controller, and a dual-port controller is added to the dual-port DRAM. The dual-port controller is configured to: sort access requests received through the two ports, and send the access requests in the sorted order to the DRAM controller for processing, to prevent a timing conflict during simultaneous access through the two ports. In addition, the dual-port DRAM may further include related components for data input, output, buffering, and the like, such as an input/output (I/O) buffer, a sense amplification and I/O circuit, a memory array, and a serial shift register. In FIG. 2, CLK represents a clock signal of the serial shift register, and SD represents output data of the serial shift register.

When the foregoing two types of dual-port DRAMs are used as memory dies in dies across which an SoC is distributed, efficiency of data communication between non-memory dies can be improved. However, there are still problems to some extent, resulting in limited usage. For example, the additional bit lines BLs and word lines WLs are introduced into the dual-port DRAM shown in FIG. 1, resulting in a decrease in storage density of the dual-port DRAM. The additional dual-port controller is introduced into the dual-port DRAM shown in FIG. 2, and the dual-port controller and the DRAM controller need to be integrated into the dual-port DRAM, resulting in poor flexibility.

Based on this, an embodiment of this disclosure provides a chip system. The chip system can ensure a function of a non-memory die without reducing storage density and flexibility of a memory die, and improve efficiency of data communication between non-memory dies.

The technical solutions in this disclosure may be applied to various communication devices. For example, the communication device may be a terminal device. The terminal device may include but is not limited to a mobile phone, a tablet computer, a computer, a notebook computer, a video camera, a camera, a wearable device, a vehicle-mounted device (for example, a car, a bicycle, an electric vehicle, an airplane, a ship, a train, or a high-speed railway), a virtual reality (VR) device, an augmented reality (AR) device, an intelligent robot, or the like.

FIG. 3 is a diagram of a structure of a terminal device according to an embodiment of this disclosure. An example in which the terminal device is a mobile phone is used for description. The mobile phone includes components such as a radio frequency (RF) circuit 110, a memory 120, an input unit 130, a display unit 140, a sensor component 150, an audio circuit 160, a processor 170, and a power supply 180. The following describes the components of the mobile phone in detail with reference to FIG. 3.

The RF circuit 110 may be configured to receive and send information, or receive and send a signal during a call. The RF circuit 110 may include but is not limited to an antenna, an amplifier, a transceiver, a coupler, a low-noise amplifier (LNA), a duplexer, and the like. Optionally, the antenna may include a plurality of receive antennas and a plurality of transmit antennas. In addition, the RF circuit 110 may further communicate with a network and another device through wireless communication, for example, communicate with an access device through a Wi-Fi network.

The memory 120 may be configured to store a software program and a module. The processor 170 performs various function applications of the mobile phone and data processing by running the software program and the module that are stored in the memory 120. The memory 120 may mainly include a program storage region and a data storage region. The program storage region may store an operating system, an application required by at least one function, and the like. The data storage region may store data (for example, audio data, image data, a phone book, or the like) that is created based on use of the mobile phone, and the like. In addition, the memory 120 may include a high-speed random-access memory (RAM), or may include a non-volatile memory such as at least one magnetic disk storage device, a flash memory device, or another volatile solid-state storage device.

The input unit 130 may be configured to: receive input digit or character information, and generate a key signal input related to user settings and function control of the mobile phone. The input unit 130 may include a touchscreen 131 and another input device 132. The touchscreen 131 is also referred to as a touch panel, and may collect a touch operation (for example, an operation performed by a user on or near the touchscreen 131 by using any proper object or accessory such as a finger or a stylus) performed by the user on or near the touchscreen 131, and drive a corresponding connection apparatus by using a preset program. The other input device 132 may include but is not limited to one or more of a physical keyboard, a function key (for example, a volume control key, a power-on/off key, or the like), a trackball, a mouse, a joystick, or the like.

The display unit 140 may be configured to display information entered by the user or information provided for the user and various menus of the mobile phone. The display unit 140 may include a display panel 141. Optionally, the display panel 141 may be configured in a form of liquid-crystal display (LCD), organic light-emitting diode (OLED), or the like. Further, the touchscreen 131 may cover the display panel 141. After detecting a touch operation on or near the touchscreen 131, the touchscreen 131 transfers the touch operation to the processor 170, to determine a type of a touch event. Then, the processor 170 provides a corresponding visual output on the display panel 141 based on the type of the touch event. Although the touchscreen 131 and the display panel 141 in FIG. 3 are used as two independent components to implement input and output functions of the mobile phone, in some embodiments, the touchscreen 131 and the display panel 141 may be integrated to implement the input and output functions of the mobile phone.

The sensor component 150 includes one or more sensors, and is configured to provide status evaluation in various aspects for the mobile phone. The sensor component 150 may include a temperature sensor, an acceleration sensor, a gyroscope sensor, a magnetic sensor, or a pressure sensor. The sensor component 150 may detect a temperature change of the mobile phone, acceleration/deceleration of the mobile phone, an orientation of the mobile phone, an on/off state of the mobile phone, relative positioning of the component, or the like. In addition, the sensor component 150 may further include an optical sensor, for example, a complementary metal-oxide-semiconductor (CMOS) or charge-coupled device (CCD) image sensor, and is used in an imaging application.

The audio circuit 160, a speaker 161, and a microphone 162 may provide an audio interface between the user and the mobile phone. The audio circuit 160 may convert received audio data into an electrical signal and transmit the electrical signal to the speaker 161, and the speaker 161 converts the electrical signal into a sound signal for output. In addition, the microphone 162 converts a collected sound signal into an electrical signal, and the audio circuit 160 receives the electrical signal, converts the electrical signal into audio data, and then outputs the audio data to the RF circuit 110, to send the audio data to, for example, another mobile phone, or outputs the audio data to the memory 120 for further processing.

The processor 170 is a control center of the mobile phone, is connected to all the parts of the entire mobile phone through various interfaces and lines, and executes various functions of the mobile phone and processes data by running or executing the software program and/or the module that are/is stored in the memory 120 and by invoking data stored in the memory 120, to perform overall monitoring on the mobile phone. Optionally, the processor 170 may include one or more processing units. For example, the processor 170 may integrate an application processor and a modem processor. The application processor mainly processes an operating system, a user interface, an application, and the like. The modem processor mainly processes wireless communication. It may be understood that the modem processor may alternatively not be integrated into the processor 170.

The mobile phone further includes the power supply 180 (for example, a battery) that supplies power to the components. Optionally, the power supply may be logically connected to the processor 170 by using a power management system, to implement functions such as charging management, discharging management, and power consumption management by using the power management system.

Further, the mobile phone may further include a connectivity chip 190. A Wi-Fi chip may be integrated into the chip 190. In this embodiment of this disclosure, an antenna for receiving or sending a plurality of data streams or a single data stream may be an antenna of a Wi-Fi chip. In addition, one or more of a Bluetooth module, a near-field communication (NFC) module, a global navigation satellite system GNSS) module, or a frequency modulation (FM) module may be further integrated into the chip 190. Details are not described herein in this disclosure.

A person skilled in the art may understand that the structure of the mobile phone shown in FIG. 3 does not constitute any limitation on the mobile phone. The mobile phone may include components more or fewer than those shown in the figure, or combine some components, or have a different component arrangement.

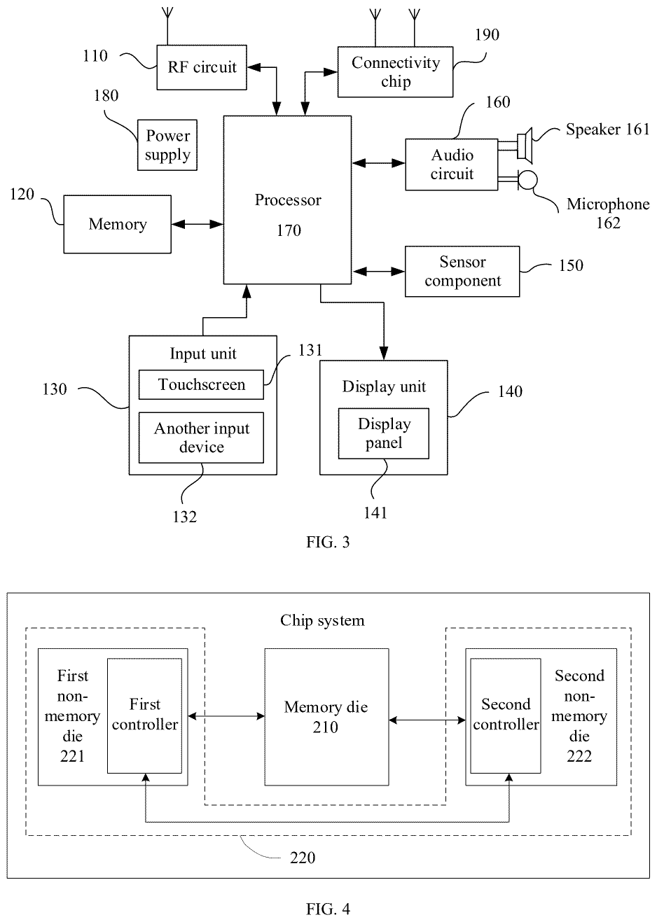

FIG. 4 is a diagram of a structure of a chip system according to an embodiment of this disclosure. The chip system may be used in the communication device provided above. The chip system may include: a memory die 210 and at least two non-memory dies 220. The at least two non-memory dies 220 may include a first non-memory die 221 and a second non-memory die 222. The first non-memory die 221 includes a first controller, the second non-memory die includes a second controller, and the first controller and the second controller are configured to control access to the memory die 210.

In a possible embodiment, at least two interfaces of the memory die 210 are respectively coupled to a first interface of the first non-memory die 221 and a first interface of the second non-memory die 222 for the first controller and the second controller to control access to the memory die 210. A second interface of the first non-memory die 221 is coupled to a second interface of the second non-memory die 222 for the first controller to communicate with the second controller.

The die may also be referred to as a grain, a bare crystal, a particle, a core particle, or the like, and may be a grain cut from a wafer. The memory die 210 may be a die having a storage function. The non-memory die may be a die having a data processing function or a computing function, and the non-memory die may access the memory die 210.

Optionally, the memory die 210 may include but is not limited to: a DRAM, a static RAM (SRAM), a synchronous DRAM (SDRAM), a double data rate SDRAM (DDR SDRAM), and the like.

Optionally, the at least two non-memory dies 220 may include but are not limited to: a CPU, a modem, an ISP, a DSP, a GPU, an NPU, a TPU, a network interface card, various accelerators, and the like.

In addition, the at least two interfaces of the memory die 210 may include two or more interfaces. Both the first interface and the second interface of the first non-memory die 221 may include one or more interfaces. Both the first interface and the second interface of the second non-memory die 222 may also include one or more interfaces. The first interface of the first non-memory die 221 and the first interface of the second non-memory die 222 may be coupled to different interfaces in the at least two interfaces of the memory die 210.

For example, the memory die 210 includes four interfaces, which are represented as I1 to I4. The first interface of the first non-memory die 221 and the first interface of the second non-memory die 222 each include two interfaces, and the two interfaces that the first interface of the first non-memory die 221 includes and the two interfaces that the first interface of the second non-memory die 222 includes are respectively represented as J1 and J2 as well as K1 and K2. The second interface of the first non-memory die 221 and the second interface of the second non-memory die 222 each include one interface, and the one interface that the second interface of the first non-memory die 221 includes and the one interface that the second interface of the second non-memory die 222 includes are respectively represented as J3 and K3. The interfaces I1 and 12 of the memory die 210 may be correspondingly coupled to the interfaces J1 and J2 of the first non-memory die 221. The interfaces 13 and 14 of the memory die 210 may be correspondingly coupled to the interfaces K1 and K2 of the second non-memory die 222. The interface J3 of the first non-memory die 221 may be coupled to the interface K3 of the second non-memory die 222.

In the chip system, a part of the interfaces of the memory die are coupled to the first interface of the first non-memory die 221, so that the first non-memory die 221 can access the memory die 210 through the first interface of the first non-memory die 221. Similarly, a part of the interfaces of the memory die are coupled to the first interface of the second non-memory die 222, so that the second non-memory die 222 can access the memory die 210 through the first interface of the second non-memory die 222. The second interface of the first non-memory die 221 is coupled to the second interface of the second non-memory die 222, so that the first non-memory die 221 and the second non-memory die 222 can directly communicate with each other through the second interfaces. For example, the first non-memory die 221 and the second non-memory die 222 may negotiate a control right (or referred to as an access right) of the memory die 210 through the second interfaces.

In this embodiment of this disclosure, both the first non-memory die 221 and the second non-memory die 222 may access the memory die 210, so that the first non-memory die 221 and the second non-memory die 222 can use the memory die 210 to perform respective functions. In addition, both the first non-memory die 221 and the second non-memory die 222 may access the memory die 210. In other words, different non-memory dies may access a same memory die. In this way, the first non-memory die 221 and the second non-memory die 222 may implement data communication by using the memory die 210, to improve efficiency of data communication between the first non-memory die 221 and the second non-memory die 222. In addition, this can save the memory die 210 and reduce costs. For example, the first non-memory die 221 writes data into the memory die 210, and the second non-memory die 222 reads the data from the memory die 210; or the second non-memory die 222 writes data into the memory die 210, and the first non-memory die 221 reads the data from the memory die 210.

Optionally, the at least two non-memory dies 220 access the memory die 210 through time division multiplexing. In other words, the at least two non-memory dies 220 may access the memory die 210 at different times. When the at least two non-memory dies 220 include the first non-memory die 221 and the second non-memory die 222, the first non-memory die 221 and the second non-memory die 222 may access the memory die 210 through time division multiplexing. In this case, the memory die 210 may also be referred to as a dual-port memory die. For example, the memory die 210 may be a dual-port DRAM.

In a possible embodiment, when the first non-memory die 221 needs to access the memory die 210, the first controller of the first non-memory die 221 may be configured to send first indication information through the second interface of the first non-memory die 221, where the first indication information indicates that the first non-memory die 221 is to access the memory die 210. In this way, when the second non-memory die 222 receives the first indication information through the second interface of the second non-memory die 222, the second non-memory die 222 may not access the memory die 210, to transfer the control right of the memory die 210 to the first non-memory die 221. Optionally, the second non-memory die 222 may further send first response information through the second interface of the second non-memory die 222, where the first response information may be used to confirm that the first non-memory die 221 accesses the memory die 210.

Similarly, when the second non-memory die 222 needs to access the memory die 210, the second controller of the second non-memory die 222 may be configured to send second indication information through the second interface of the second non-memory die 222, where the second indication information indicates that the second non-memory die 222 is to access the memory die 210. In this way, when the first non-memory die 221 receives the second indication information through the second interface of the first non-memory die 221, the first non-memory die 221 may not access the memory die 210, to transfer the control right of the memory die 210 to the second non-memory die 222. Optionally, the first non-memory die 221 may further send second response information through the second interface of the first non-memory die 221, where the second response information may be used to confirm that the second non-memory die 222 accesses the memory die 210.

In this embodiment of this disclosure, the at least two non-memory dies 220 access the memory die 210 through time division multiplexing. In this way, each of the at least two non-memory dies 220 may access the memory die 210 at different times. In other words, only one non-memory die accesses the memory die 210 at a same time. Therefore, the memory die 210 does not need to be greatly improved, and storage density and flexibility of the memory die 210 are not reduced.

Further, as shown in FIG. 5, the at least two non-memory dies 220 further include a third non-memory die 223, the third non-memory die 223 includes a third controller, and the third controller is configured to control access to the memory die 210.

In a possible embodiment, the at least two interfaces of the memory die 210 are further coupled to a first interface of the third non-memory die 223 for the third controller to control access to the memory die 210. A second interface of the third non-memory die 223 is coupled to both the second interface of the first non-memory die 221 and the second interface of the second non-memory die 222 for the third controller to communicate with the first controller and the second controller.

The at least two interfaces of the memory die 210 are further coupled to the first interface of the third non-memory die 223, so that the third non-memory die 223 can access the memory die 210 through the first interface of the third non-memory die 223. In this way, the third non-memory die 223 may use the memory die 210 to perform a function of the third non-memory die 223.

In addition, the first non-memory die 221, the second non-memory die 222, and the third non-memory die 223 all may access the memory die 210. In other words, different non-memory dies may access a same memory die. In this way, any two of the three non-memory dies may implement data communication by using the memory die 210, to improve efficiency of data communication between non-memory dies.

In addition, the second interface of the third non-memory die 223 is coupled to both the second interface of the first non-memory die 221 and the second interface of the second non-memory die 222, so that the three non-memory dies can directly communicate with each other through the second interfaces. For example, the first non-memory die 221, the second non-memory die 222, and the third non-memory die 223 may negotiate the control right of the memory die 210 through the second interfaces, to access the memory die 210 in a time division multiplexing manner.

In a possible embodiment, when the third non-memory die 223 needs to access the memory die 210, the third memory of the third non-memory die 223 may be configured to send third indication information through the second interface of the third non-memory die 223, where the third indication information indicates that the third non-memory die 223 is to access the memory die 210. In this way, when both the first non-memory die 221 and the second non-memory die 222 receive the third indication information through the respective second interfaces, the first non-memory die 221 and the second non-memory die 222 may not access the memory die 210, to transfer the control right of the memory die 210 to the third non-memory die 223. Optionally, the first non-memory die 221 and the second non-memory die 222 may further send third response information through the respective second interfaces, and the third response information may be used to confirm that the third non-memory die 223 accesses the memory die 210.

It may be understood that, the foregoing descriptions are provided only by using an example in which the at least two non-memory dies 220 include three non-memory dies. The at least two non-memory dies 220 may further include more non-memory dies. The more non-memory dies may be coupled to the memory die 210 and another non-memory die in a manner similar to that used by the foregoing third non-memory die 223, and implement time division multiplexing of the memory die 210 in the foregoing manner of negotiating the control right of the memory die 210. A quantity of non-memory dies included in the at least two non-memory dies 220 is not limited in embodiments of this disclosure.

Further, each of the at least two non-memory dies 220 may include a controller, and the controller may be configured to control access to the memory die 210. For example, the memory die 210 may include a memory array, and the controller may be configured to write data into the memory array, or read data stored in the memory array.

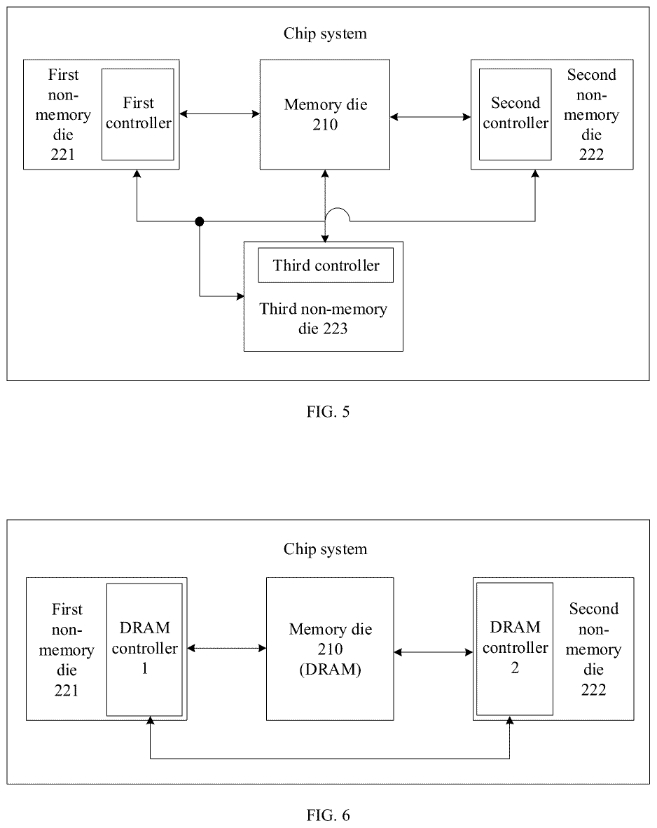

For ease of understanding, the following uses an example in which the at least two non-memory dies 220 include the first non-memory die 221 and the second non-memory die 222, the memory die 210 is a DRAM, and the controller is a DRAM controller for description. For example, as shown in FIG. 6, the first non-memory die 221 includes a DRAM controller 1, and the second non-memory die 222 includes a DRAM controller 2. The DRAM controller 1 may access the memory die 210 through a first interface of the first non-memory die 221, the DRAM controller 2 may access the memory die 210 through a first interface of the second non-memory die 222, and the DRAM controller 1 and the DRAM controller 2 may further communicate with each other through a second interface of a non-memory die at which the DRAM controller 1 and the DRAM controller 2 are located.

It may be understood that, the foregoing descriptions in FIG. 6 are provided by using an example in which each of the at least two non-memory dies 220 includes one controller. Each of the at least two non-memory dies 220 may not be integrated with a controller. For example, a controller may be integrated into the memory die 210, or an independent controller is disposed between the memory die 210 and the at least two non-memory dies 220. The example in FIG. 6 constitutes no limitation on this embodiment of this disclosure.

Further, in a chip system, the memory die 210 and the at least two non-memory dies 220 may be packaged together, or the memory die 210 and a part of the at least two non-memory dies 220 may be packaged together. For ease of understanding, the following uses an example in which the at least two non-memory dies 220 include the first non-memory die 221 and the second non-memory die 222 for description.

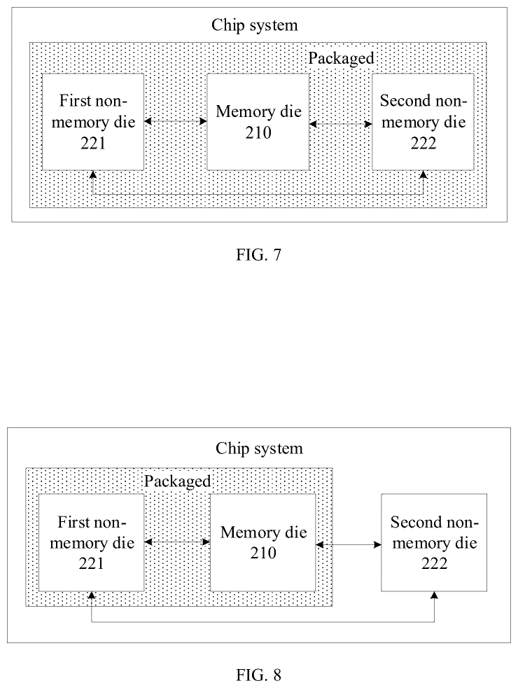

In a possible embodiment, as shown in FIG. 7, the chip system includes the memory die 210, the first non-memory die 221, and the second non-memory die 222, where the memory die 210, the first non-memory die 221, and the second non-memory die 222 are packaged together. FIG. 7 does not show the first controller of the first non-memory die 221 and the second controller of the second non-memory die 222.

In another possible embodiment, as shown in FIG. 8, the chip system includes the memory die 210, the first non-memory die 221, and the second non-memory die 222, where the memory die 210 and the first non-memory die 221 are packaged together. FIG. 8 does not show the first controller of the first non-memory die 221 and the second controller of the second non-memory die 222.

In this embodiment of this disclosure, the memory die 210 and the at least two non-memory dies 220 may be packaged together, or the memory die 210 and a part of the at least two non-memory dies 220 are packaged together, so that an integration level of the chip system can be improved, and an area of the chip system can be reduced.

Based on this, an embodiment of this disclosure further provides a communication device. The communication device may include a printed circuit board (PCB) and a chip system disposed on the printed circuit board PCB. The chip system may be any chip system provided above.

Optionally, the communication device may be a mobile terminal. For example, the mobile terminal may include but is not limited to a mobile phone, a tablet computer, a notebook computer, a video camera, a camera, a wearable device, a vehicle-mounted device, and the like. This is not specifically limited in embodiments of this disclosure.

It should be noted that the foregoing detailed descriptions about the chip system may be correspondingly referenced to the embodiment corresponding to the communication device. Details are not described in this embodiment of this disclosure again.

In conclusion, it should be noted that the foregoing descriptions are merely specific implementations of this disclosure, but are not intended to limit the protection scope of this disclosure. Any variation or replacement within the technical scope disclosed in this disclosure shall be within the protection scope of this disclosure. Therefore, the protection scope of this disclosure shall be subject to the protection scope of the claims.

1. A chip system, comprising:
a memory die;
a first non-memory die, comprising a first controller, wherein the first controller is configured to control access to the memory die; and
a second non-memory die comprising a second controller configured to control access the memory die.

2. The chip system of claim 1, wherein the memory die comprises:
a first interface; and a second interface,
wherein the first non-memory die further comprises:
a third interface coupled to the first interface and the second interface; and
a fourth interface,
wherein the first controller is further configured to further control access to the memory die through the third interface, the first interface, and the second interface,
wherein the second non-memory die further comprises:
a fifth interface coupled to the first interface and the second interface;
a sixth interface coupled to the fourth interface, and
wherein the second controller is further configured to:
further control access to the memory die through the fifth interface, the first interface, and the sixth interface; and
communicate with the first controller through the sixth interface and the fourth interface.

3. The chip system of claim 1, wherein the first non-memory die and the second non-memory die are further configured to access the memory die using time-division multiplexing.

4. The chip system according to claim 2, wherein the first controller is further configured to send indication information through the fourth interface, and wherein the first indication information indicates that the first non-memory die will access the memory die.

5. The chip system of claim 1, further comprising a third non-memory die, wherein the third non-memory die comprises a third controller, and wherein the third controller is configured to control access to the memory die.

6. The chip system of claim 5, wherein the memory die comprises:
a first interface; and
a second interface,
wherein the first non-memory die further comprises a fourth interface,
wherein the second non-memory die further comprises a sixth interface,
wherein the third non-memory die further comprises:
a seventh interface coupled to the first interface and the second interface; and
an eighth interface coupled to the fourth interface and the sixth interface,
wherein the third controller is further configured to:
further control access to the memory die through the seventh interface, the first interface, and the second interface;
communicate with the first controller through the eighth interface and the fourth interface; and
communicate with the second controller through the eighth interface and the sixth interface.

7. The chip system of claim 6, wherein the third controller is further configured to send indication information through the eighth interface, and wherein the third indication information indicates that the third non-memory die will access the memory die.

8. The chip system of claim 1, wherein the memory die, a first part of the first non-memory die, and a second part of the second non-memory die are packaged together.

9. The chip system of claim 1, wherein the memory die, the first non-memory die, and the second non-memory die are packaged together.

10. The chip system of claim 1, wherein the memory die is a dynamic random-access memory (DRAM).

11. The chip system of claim 1, wherein the first non-memory die is a first central processing unit (CPU), and wherein the second non-memory die is a second CPU.

12. The chip system of claim 1, wherein the first non-memory die is a first modem, and wherein the second non-memory die is a second modem.

13. The chip system of claim 1, wherein the first non-memory die is a first image signal processor (ISP), and wherein the second non-memory die is a second ISP.

14. The chip system of claim 1, wherein the first non-memory die is a first digital signal processor (DSP), and wherein the second non-memory die is a second DSP.

15. The chip system of claim 1, wherein the first non-memory die is a first graphics processing unit (GPU), and wherein the second non-memory die is a second GPU.

16. The chip system of claim 1, wherein the first non-memory die is a neural processing unit (NPU), and wherein the second non-memory die is a first tensor processing unit (TPU).

17. The chip system of claim 1, wherein the first non-memory die is a first network interface card, and wherein the second non-memory die is a second network interface card.

18. The chip system of claim 2, wherein the second controller is further configured to send indication information through the sixth interface, and wherein the indication information indicates that the second non-memory die will access the memory die.

19. A chip system, comprising:
a memory die;
a first non-memory die comprising a first controller, wherein the first controller is configured to:
control access to the memory die; and
access the memory die using time-division multiplexing; and
a second non-memory die comprising a second controller, wherein the second controller is configured to:
control access to the memory die; and
access the memory die using time-division multiplexing.

20. A chip system, comprising:
a memory die;
a first non-memory die comprising:
a first part; and
a first controller configured to control access to the memory die; and
a second non-memory die comprising:
a second part; and
a second controller configured to control access to the memory die, wherein the memory die, the first part, and the second part are packaged together.
